(19) United States
(12) Patent Application Publication
(10) Pub. No.: US 2013/0207934 A1
(43) Pub. Date: Aug. 15, 2013

(54) INPUT DEVICE AND TOUCH POSITION DETECTING METHOD THEREOF

(71) Applicants: Se-Eun Jang, Yongin-si (KR); Xiaoling Wu, Yongin-si (KR); Chul-Yong Joung, Yongin-si (KR); Young-Ho Shin, Yongin-si (KR)

(72) Inventors: Se-Eun Jang, Yongin-si (KR); Xiaoling Wu, Yongin-si (KR); Chul-Yong Joung, Yongin-si (KR); Young-Ho Shin, Yongin-si (KR)

(73) Assignee: ATLab Inc., Yongin-si (KR)

(21) Appl. No.: 13/824,611

(22) PCT Filed: Oct. 18, 2011
(86) PCT No.: PCT/KR2011/007727

§ 371 Date: Mar. 18, 2013

(30) Foreign Application Priority Data
Oct. 21, 2010 (KR) 10-2010-0103008

(51) Int. Cl. G06F 3/044

(52) U.S. Cl. CPC G06F 3/044
USPC 345/174

(57) ABSTRACT

Provided are an input device and a touch position detecting method thereof. The input device includes a touch panel part configured to output a measurement value according to a touch position of a touch object; and a touch position detecting part configured to generate a raw frame based on the measurement value and generate at least one cluster with reference to a cell having a maximum value in the raw frame, wherein, when there is an overlapped cell simultaneously included in a plurality of clusters, the touch position detecting part performs a clustering operation of dividing a value of the overlapped cell into values of the plurality of clusters according to values of cells adjacent to the overlapped cell and generating the at least one cluster, and calculates coordinates of the touch position with respect to each of the at least one cluster.

### TECHNICAL FIELD

The present invention relates to an input device, and more particularly, to an input device having a touch panel and a touch position detecting method thereof.

### BACKGROUND ART

Personal computers, mobile transmission devices, and other information processing devices perform various functions using input devices. In recent times, input devices having touch panels are becoming widely used as such input devices.

In general, touch panels installed on surfaces of display devices such as CRTs, LCDs, PDPs, ELs (electroluminescences), and so on, can be fabricated using an ITO (complex oxide of indium-tin) film.

When a user touches a specific position on a touch panel, and so on, with a touch object (for example, a finger, a stylus pen, etc.), an input device having the touch panel may display various information through the display device according to a touch position, or may be operated to perform a specific function according to a position touched with an instrument having the touch panel.

### DISCLOSURE

### Technical Problem

In order to solve the foregoing and/or other problems, it is an aspect of the present invention to provide an input device capable of more precisely detecting a touch position.

It is another aspect of the present invention to provide a touch position detecting method of the input device to accomplish the above aspect.

### Technical Solution

The foregoing and/or other aspects of the present invention may be achieved by providing an input device including: a touch panel part configured to output a measurement value according to a touch position of a touch object; and a touch position detecting part configured to generate a raw frame based on the measurement value and generate at least one cluster with reference to a cell having a maximum value in the raw frame, wherein, when there is an overlapped cell simultaneously included in a plurality of clusters, the touch position detecting part performs a clustering operation of dividing a value of the overlapped cell into values of the plurality of clusters according to values of cells adjacent to the overlapped cell and generating the at least one cluster, and calculates coordinates of the touch position with respect to each of the at least one cluster.

In addition, when there is an overlapped cell and the overlapped cell is simultaneously included in a first cluster and a second cluster, the touch position detecting part may divide the overlapped cell into the first cluster and the second cluster according to a ratio of a sum of cells included in the first cluster among cells adjacent to the overlapped cell and a sum of cells included in the second cluster among the cells adjacent to the overlapped cell, or the touch position detecting part may divide the overlapped cell into the first cluster and the second cluster according to a ratio of a sum of cells included in the first cluster among cells adjacent to upper, lower, left and right sides of the overlapped cell and a sum of cells included in the second cluster among the cells adjacent to the upper, lower, left and right sides of the overlapped cell.

Further, the touch position detecting part may calculate the coordinates of the touch position by calculating a weighted geometrical center of each of the at least one cluster.

In a first type of the input device, the touch position detecting part may perform the clustering operation to detect an increase or decrease of each cell adjacent to the cell having the maximum value of the raw frame with reference to the cell having the maximum value such that cells reduced with reference to the cell having the maximum value of the adjacent cells constitute the same cluster as the cell having the maximum value.

In a first type of the input device, the touch position detecting part may calculate a link frame by subtracting the cluster from the raw frame, detect a cell having a maximum value in the link frame, and detect an increase or decrease with respect to each of the cells adjacent to the cell of the raw frame corresponding to the cell having the maximum value of the link frame with reference to the cell of the corresponding raw frame, thereby performing the clustering operation.

In a second type of the input device, the touch position detecting part may perform a clustering operation such that a certain region of cells constitute one cluster around the cell having the maximum value.

In a second type of the input device, the touch position detecting part may calculate a link frame by subtracting the cluster from the raw frame, detect a cell having a maximum value in the link frame, and perform the clustering operation such that a certain region of cells in the raw frame constitute one cluster around a cell of the raw frame corresponding to a cell having a maximum value in the link frame, or performs the clustering operation such that a certain region of cells of the link frame constitutes one cluster around a cell having a maximum value in the link frame.

In addition, the touch position detecting part may perform the clustering operation until all cells of the link frame are equal to or less than a threshold value.

Further, the touch position detecting part may combine clusters having a distance therebetween equal to or less than a reference distance to constitute one cluster.

Furthermore, the touch position detecting part may display that there is a large touch when a size of the cluster is equal to or larger than a reference size.

In addition, the touch panel part may include: a touch pad part having a plurality of touch pads disposed on one layer and connected to channels corresponding thereto, respectively; and a delay time measuring part configured to measure capacitances of the plurality of touch pads through the channels to output the measurement value.

Further, the plurality of touch pads of the touch pad part of the touch panel part may be disposed on the one layer in a matrix and spaced apart from each other.

Furthermore, the delay time measuring part may include: a pulse generating part configured to generate a pulse signal; a plurality of detection signal generating parts connected to the channels, respectively, and configured to delay the pulse signal according to the capacitances of the touch pads connected to the channels to output a plurality of detection signals; a reference signal generating part configured to output a reference signal in response to the pulse signal; and a delay time calculating part configured to calculate a delay time difference between each of the plurality of detection signals and the reference signal and output the delay time difference as the measurement value.

In addition, the plurality of touch pads may have different sizes according to positions on the touch pad part, and connection lines connecting the plurality of touch pads to the channels corresponding thereto, respectively, may have different lengths according to positions on the touch pad part.

Further, the input device may further include a pre-processing part configured to input the measurement value to remove noises, and compensate a difference in size of the touch pads and a difference in length of the connection lines.

Furthermore, the input device may further include a post-processing part configured to input the coordinates of the touch position to remove noises, and align and output the coordinates.

In addition, the touch position detecting part may include: a clustering part configured to perform a clustering operation of generating the raw frame based on the measurement value, detecting a maximum value of the measurement value, and generating the at least one cluster with reference to the cell having the maximum value in the raw frame; and a center point calculating part configured to calculate center point coordinates of each of the clusters using a weighted average of each cluster, and output the center point coordinates as the coordinates of the touch position.

Further, the center point calculating part may calculate the center point coordinates after subtracting an offset value from the cells constituting each of the clusters.

In addition, another aspect of the present invention may be achieved by providing a touch position detecting method of an input device having a touch panel part of outputting a measurement value according to a touch position of a touch object, which includes: generating a raw frame based on the measurement value; generating a cluster with reference to a cell having a maximum value in the raw frame, wherein, if there is an overlapped cell simultaneously included in a plurality of clusters, a value of the overlapped cell is divided into the plurality of clusters according to a value of cells adjacent to the overlapped cell to generate the at least one cluster; and calculating coordinates of the touch position with respect to the cluster.

Further, in the touch position detecting method, when there is an overlapped cell and the overlapped cell is simultaneously included in a first cluster and a second cluster, generating the cluster may divide the overlapped cell into the first cluster and the second cluster according to a ratio of a sum of cells included in the first cluster among cells adjacent to the overlapped cell and a sum of cells included in the second cluster among cells adjacent to the overlapped cell, or generating the cluster may divide the overlapped cell into the first cluster and the second cluster according to a ratio of a sum of cells included in the first cluster among cells adjacent to upper, lower, left and right sides of the overlapped cell and a sum of cells included in the second cluster among the cells adjacent to the upper, lower, left and right sides of the overlapped cell.

Furthermore, calculating the coordinates of the touch position may calculate the coordinates of the touch position by calculating a weighted geometrical center of each of the at least one cluster.

In a first type, generating the cluster may include: detecting an increase or decrease with respect to each of the cells adjacent to the cell having the maximum value of the raw frame with reference to the cell having the maximum value; and performing a clustering operation such that cells reduced with reference to the cell having the maximum value among the adjacent cells constitute the same cluster as the cell having the maximum value.

In this case, the touch position detecting method may further include: calculating a link frame by subtracting the cluster from the raw frame; detecting a cell having a maximum value in the link frame; and performing a clustering operation by detecting an increase or decrease with respect to each of the cells adjacent to the cell of the raw frame corresponding to the cell having the maximum value of the link frame with reference to the cell of the corresponding raw frame.

In a second type, generating the cluster may include constituting a certain region of cells around the cell having the maximum value as one cluster.

In this case, the touch position detecting method may further include: calculating a link frame by subtracting the cluster from the raw frame; detecting a cell having a maximum value in the link frame; and performing a clustering operation such that a certain region of cells of the raw frame constitute one cluster around the cell of the raw frame corresponding to the cell having the maximum value in the link frame, or performing a clustering operation such that a certain region of cells of the link frame constitute one cluster around the cell having the maximum value in the link frame.

In addition, the touch position detecting method may further include combining clusters having a distance therebetween equal to or less than a reference distance into one cluster.

Further, the touch position detecting method may further include displaying that there is a large touch when a size of the cluster is equal to or larger than a reference size.

Furthermore, calculating the coordinates may include calculating center point coordinates of the cluster using a weighted average with respect to the cluster, and outputting the center point coordinates as coordinates of the touch position. In this case, calculating the coordinates may include calculating the center point coordinates after subtracting an offset value with respect to each cell constituting the cluster.

In addition, the touch panel part may include a plurality of touch pads disposed on one layer to be spaced apart from each other and connected to channels corresponding thereto, respectively. In this case, each of the plurality of touch pads may have different sizes according to positions on the touch pad part, and connection lines connecting the plurality of touch pads to the corresponding channels may have different lengths according to positions on the touch pad part.

In this case, the touch position detecting method may further include inputting the measurement value to remove noises, and compensating a difference in size of the touch pads and a difference in length of the connection lines connecting the touch pads to the corresponding channels, respectively.

In addition, the touch position detecting method may further include removing noises from the coordinates of the touch position, and aligning and outputting the coordinates of the touch position.

### Advantageous Effects

According to the present invention, the input device and the touch position detection method thereof in accordance with the present invention can more precisely detect a touch position.

### DESCRIPTION OF DRAWINGS

The above and other aspects and advantages of the present invention will become apparent and more readily appreciated from the following description of exemplary embodiments, taken in conjunction with the accompanying drawings of which:

FIG. 1 shows a configuration of an embodiment of an input device in accordance with the present invention;

FIG. 2 shows a configuration of an embodiment of a touch panel part of the input device in accordance with the present invention shown in FIG. 1;

FIG. 3 shows a configuration of an embodiment of a touch pattern part of the touch panel part of the input device in accordance with the present invention shown in FIG. 2;

FIG. 4 shows a configuration of an embodiment of a delay time measuring part of the touch panel part of the input device in accordance with the present invention shown in FIG. 2;

FIG. 5 is a flowchart for explaining a clustering method of a touch position detecting method of the input device in accordance with the present invention;

FIG. 6 is a flowchart for explaining a coordinate determining method of the touch position detecting method of the input device in accordance with the present invention;

FIG. 7 is a view for explaining a first embodiment of the clustering method of the touch position detecting method of the input device in accordance with the present invention;

FIG. 8 is a view for explaining the first embodiment of the clustering method of the touch position detecting method of the input device in accordance with the present invention, showing the clustering method of cells in a diagonal direction;

FIG. 9 is a view for explaining a method of dividing overlapping cells in the touch position detecting method of the input device in accordance with the present invention;

FIG. 10 is a view showing clusters on which an overlapping cell dividing operation was performed among the clusters detected according to the first embodiment of the clustering method of the touch position detecting method of the input device in accordance with the present invention;

FIG. 11 is a view for explaining a second embodiment of the clustering method of the touch position detecting method of the input device in accordance with the present invention;

FIG. 12 is a view showing clusters on which an overlapping cell dividing operation was performed among the clusters detected according to the second embodiment of the clustering method of the touch position detecting method of the input device in accordance with the present invention; and

FIG. 13 is a view for explaining a third embodiment of the clustering method of the touch position detecting method of the input device in accordance with the present invention.

### MODE FOR INVENTION

Reference will now be made in detail to the embodiments of the present invention, examples of which are illustrated in the accompanying drawings. However, it will be apparent to those skilled in the art that the following embodiments can be readily understood and modified into various types, and the scope of the present invention is not limited to the embodiments.

Hereinafter, an input device and a touch position detecting method thereof will be described with reference to the accompanying drawings.

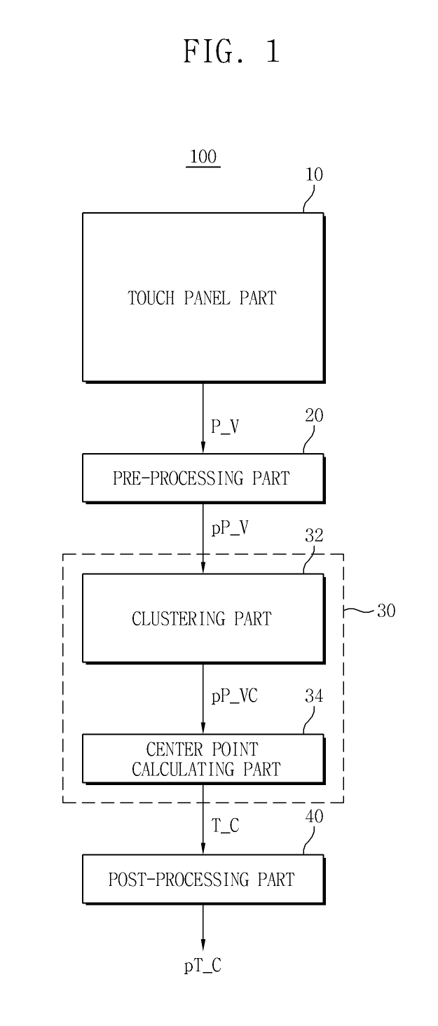

FIG. 1 shows a configuration of an embodiment of an input device 100 in accordance with the present invention. The input device 100 in accordance with the present invention may include a touch panel part 10, a pre-processing part 20, a touch position calculating part 30, and a post-processing part 40. The touch position calculating part 30 may include a clustering part 32 and a center point calculating part 34.

Functions of the respective blocks shown in FIG. 1 will be described as follows.

The touch panel part 100 may include a plurality of touch pads, and output measurement values P_V according to touch positions of a touch object. The plurality of touch pads may have capacitance values that vary according to the presence of a touch and a touch area with the touch object, respectively. In this case, the measurement values P_V may correspond to capacitance values of the plurality of touch pads. The capacitance values may be measured by measuring a delay time of a pulse signal.

The pre-processing part 20 pre-processes the measurement values P_V to output objective measurement values pP_V. The pre-processing part 20 may remove noises by filtering the measurement values P_V or subtracting a threshold value from the measurement values. In addition, the pre-processing part 20 may perform a correction operation for offsetting errors caused by geometrical discordance of the touch pads or a difference in length of connection lines connected to the touch pads, respectively. In addition, the pre-processing part 20 may perform a correction operation for offsetting the influence of variation in process or variation in environment.

The touch position calculating part 30 inputs the objective measurement values pP_V, performs clustering of the objective measurement values pP_V with reference to a cell having a maximum value of the objective measurement values pP_V, and calculates and outputs a coordinate value T_C of each cluster.

The clustering part 32 detects a cell having a maximum value of the objective measurement values pP_V, divides the objective measurement values pP_V into at least one cluster with reference to the cell having the maximum value, and outputs the clustered measurement value pP_VC. The clustering part 32 may perform the clustering operation by detecting variation in size of each cell around the cell having the maximum value, and perform the clustering operation to form one cluster at a predetermined region of cells with reference to the cell having the maximum value. The clustering operation will be described in detail as follows.

The center point calculating part 34 inputs the clustered measurement value pP-VC, and calculates and outputs touch coordinates T_C of each cluster. The center point calculating part 34 may calculate a weighted average of the clustered measurement values pP_VC of the respective clusters to output geometric centers of the respective clusters as the touch coordinates T_C.

The post-processing part 40 inputs, sorts or filters the touch coordinates T_C, and outputs final touch coordinates pT_C.

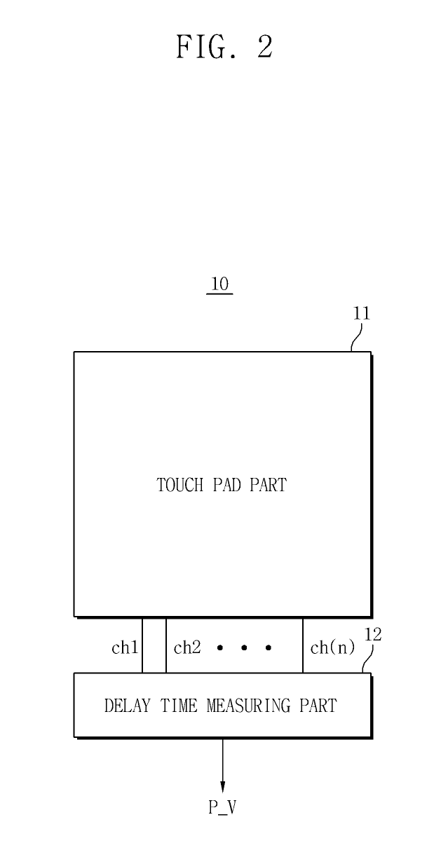

FIG. 2 shows a configuration of an embodiment of the touch panel part 10 of the input device 100 in accordance with the present invention shown in FIG. 1, and may include a touch pad part 11 and a delay time measuring part 12.

Functions of the respective blocks shown in FIG. 2 will be described in detail.

The touch pad part 11 may include a plurality of touch pads connected to a plurality of channels ch1 to ch(n). The plurality of touch pads may have capacitance values that vary according to the presence of a touch with the touch object and/or a touch level with the touch object (for example, a touch area with the touch object).

The delay time measuring part 12 outputs the measurement value P_V showing capacitance values of the respective touch pads through the plurality of channels ch1 to ch(n). The delay time measuring part 12 may measure a time at which the pulse signal is delayed by the capacitance values of the respective touch pads and output the delayed time as the measurement value P_V.

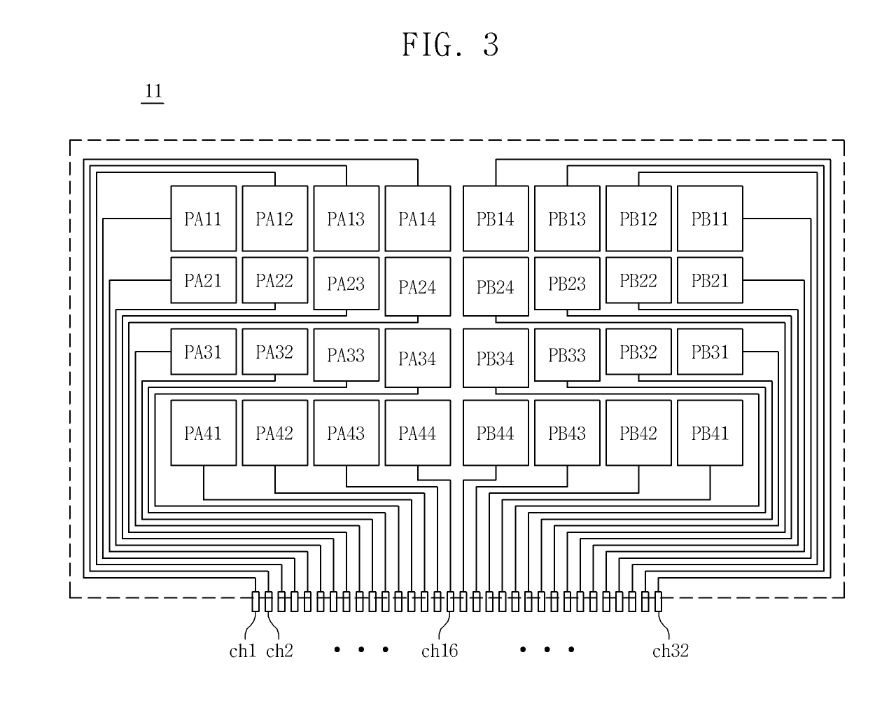

FIG. 3 shows a configuration of an embodiment of the touch pad part 11 of the touch panel part 10 of the input device 100 of FIG. 2 in accordance with the present invention. As shown in FIG. 3, the touch pad part 11 may have a symmetrical shape.

As shown in FIG. 3, the touch pad part 11 of the touch panel part 10 of the input device 100 in accordance with the present invention may be formed on one layer. The touch pads PA11 to PA44 and PB11 to PB44 of the touch pad part 11 may be disposed on one layer in a matrix. In addition, the touch pads PA11 to PA44 and PB11 to PB44 may be connected one-to-one to corresponding channels of the plurality of channels ch1 to ch32, respectively. Further, areas of the touch pads PA11 to PA44 and PB11 to PB44 may be determined according to positions of the touch pads on the touch pad part 11. Furthermore, lengths of the connection lines for connecting the corresponding channels ch1 and ch2 to the touch pads PA11 to PA44 and PB11 to PB44 may be determined according to positions of the touch pads on the touch pad part 11. In addition, the touch pads PA11 to PA44 and PB11 to PB44 have capacitances that vary according to the presence of a touch with the touch object and/or a touch level with the touch object (for example, a touch area with the touch object).

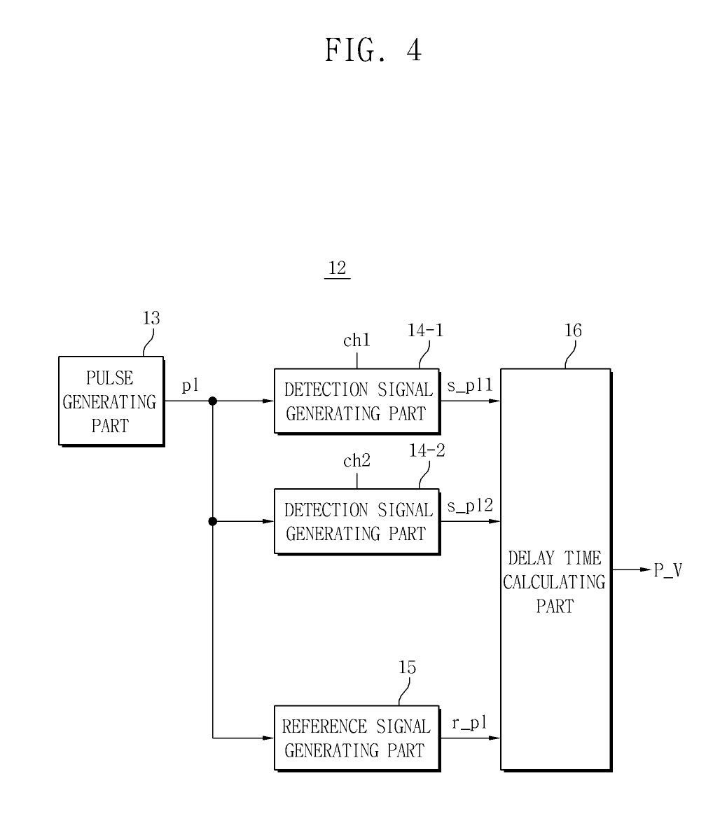

FIG. 4 shows a configuration of an embodiment of the delay time measuring part 12 of the touch panel part 10 of the input device 100 of FIG. 2 in accordance with the present invention, and the delay time measuring part 12 may include a pulse generating part 13, a plurality of detection signal generating parts 14-1, 14-2, . . . , a reference signal generating part 15, and a delay time calculating part 16. The plurality of detection signal generating parts 14-1, 14-2, . . . may be connected to the channels corresponding thereto, respectively.

Functions of the blocks shown in FIG. 4 will now be described.

The pulse generating part 13 outputs a pulse signal p1.

The detection signal generating parts 14-1, 14-2, . . . delay the pulse signal p1 to output detection signals s_p11, s_p12, . . . according to capacitances of the touch pads connected to the connected channels ch1, ch2, . . . , respectively.

The reference signal generating part 15 outputs a reference signal r_p1 in response to the pulse signal pl. The reference signal generating part 15 may delay the pulse signal pl by a certain time to output the reference signal r_pl.

The delay time calculating part 16 may calculate a difference in delay time of the reference signal r_pl and the detection signals s_pl1, s_pl2, . . . to output the calculated difference in delay time as the measurement value P_V.

While FIG. 4 illustrates the case in which a plurality of detection signal generating parts are provided and connected to the corresponding channels, respectively, the number of the detection signal generating parts may be smaller than that of the channels. In this case, a switch may be provided to sequentially connect the plurality of channels to the detection signal generating parts.

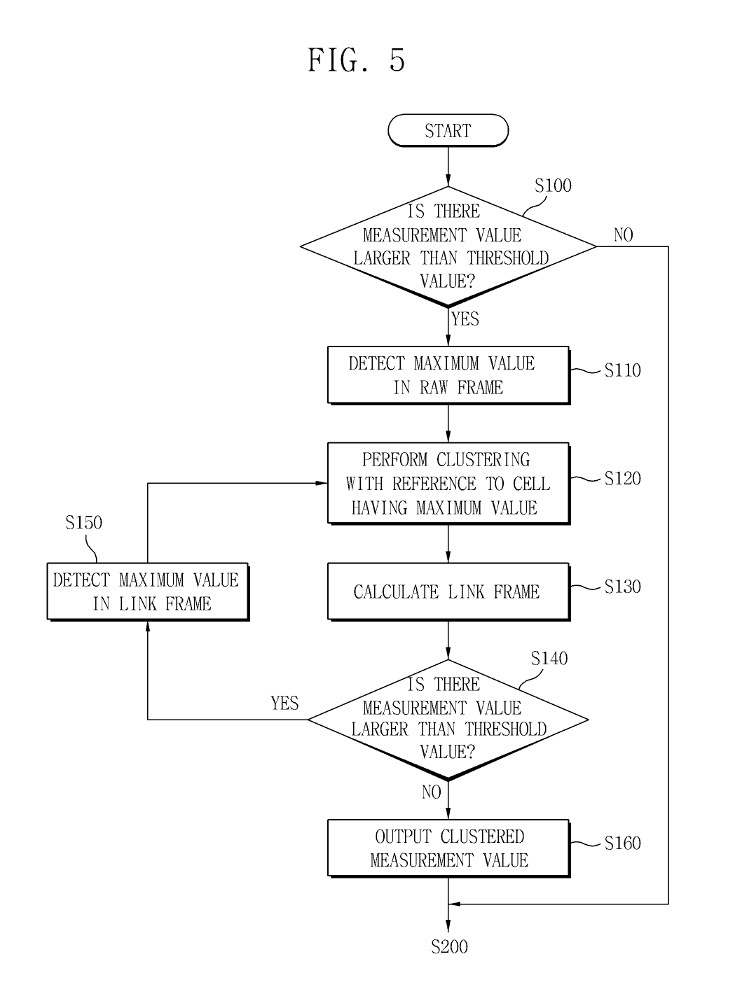

FIG. 5 is an operational flowchart for explaining a clustering method of the touch position detection method of the input device in accordance with the present invention.

The clustering method of the touch position detection method of the input device in accordance with the present invention will be described with reference to FIG. 5 as follows.

First, it is determined whether there is a value of the measurement values P_V larger than a threshold value (S100).

When no measurement value larger than the threshold value is found in step S100, the clustering method is not performed.

When a value larger than the threshold value is found in step S100, a maximum value is detected at a raw frame (S110). The raw frame means a frame constituted by the measurement values output from the touch panel part 10. For example, when the touch panel part 10 includes the touch pad part 11 as shown in FIG. 3, the raw frame may be data arranged in a matrix such that the measurement values corresponding to the touch pads PA11 to PA44 and PB11 to PB44 are located at positions corresponding to positions of the touch pads PA11 to PA44 and PB11 to PB44, respectively. Accordingly, detecting the maximum value in the raw frame is equivalent to detecting the maximum value in the measurement values.

The raw frame may be configured using the objective measurement values pP_V in which the measurement values P_V are pre-treated.

Next, the clustering operation is performed at the raw frame or a link frame with reference to a cell having a maximum value (S120). The clustering operation may be performed according to an increase/decrease with reference to the cell having the maximum value, and may be performed through a method of setting a certain region with reference to the cell having the maximum value. The clustering operation will be described below in detail.

Next, the link frame is calculated (S130). The link frame may be calculated by subtracting the cluster calculated just before from the raw frame or the link frame calculated just before.

Next, it is determined whether there is a measurement value larger than the threshold value in the link frame calculated just before (S140).

When it is determined in step S140 that there is a measurement value larger than the threshold value in the link frame calculated just before, a maximum value is detected from the link frame calculated just before (S150).

Next, steps S120 to S140 are repeated.

When it is determined in step S140 that there is no measurement value larger than the threshold value in the link frame calculated just before, the clustering operation is terminated, and the clustered measurement vale pP_VC is output. The clustered measurement value pP_VC may be constituted by at least one cluster.

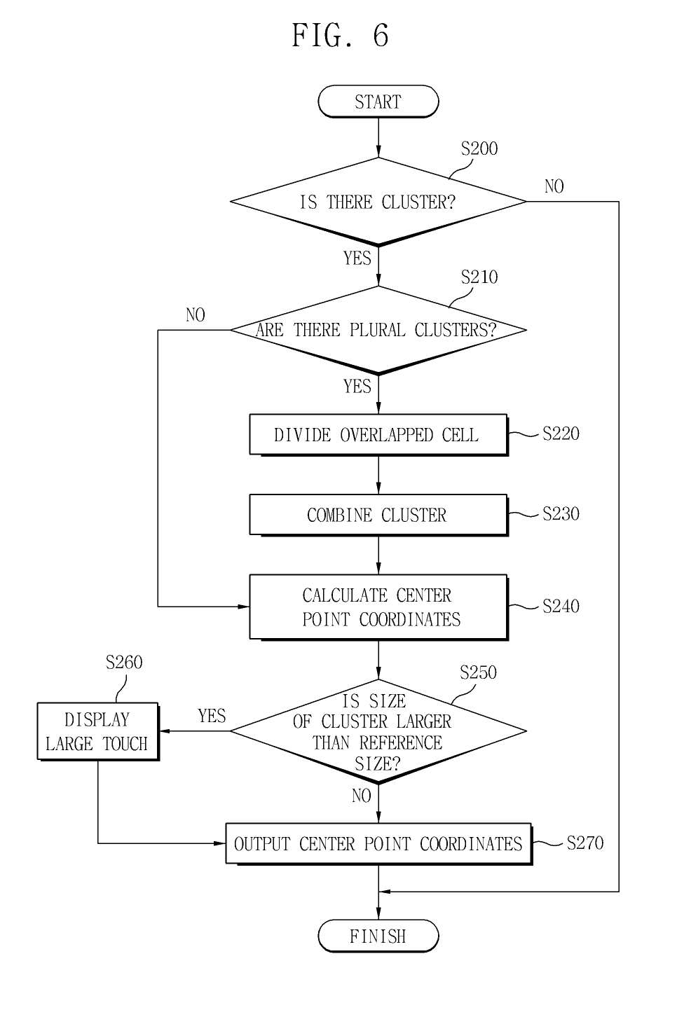

FIG. 6 is a flowchart for explaining a coordinate determining method of the touch position detecting method of the input device in accordance with the present invention.

The coordinate determining method of the touch position detecting method of the input device in accordance with the present invention will be described with reference to FIG. 6 as follows.

First, the clustered measurement value pP_VC is analyzed to determine whether there is a cluster (S200).

If it is determined in step S200 that there is no cluster, the method is terminated.

If it is determined in step S200 that there is a cluster, it is determined whether the number of clusters is plural or not (S210).

When it is determined in step S210 that the number of clusters is one, coordinates of a center point of the corresponding cluster are calculated (S240). The center point coordinates can be calculated using a weighted average. That is, the center point coordinates may be coordinates of the weighted geometrical center.

When it is determined in step S210 that the number of clusters is plural, first, it is detected whether there is an overlapped cell included in the plurality of clusters, and if there is an overlapped cell, the overlapped cell is divided (S220). That is, a measurement value of the overlapped cell may be divided to be included in each cluster according to the measurement values of the cells around the overlapped cell.

Next, when a distance between the clusters is smaller than a predetermined reference distance, the clusters having distances less than the reference distance are joined into one cluster (S230).

Next, center point coordinates are calculated with respect to each of the clusters (S240).

Next, it is determined whether a size of the cluster is larger than a reference size (S250).

If it is determined in step S250 that there is a cluster larger than the reference size, it is displayed that there is a large touch (S260).

Next, the calculated center point coordinates are output (S270).

Some of the steps of FIGS. 5 and 6 may be omitted in the touch position detecting method of the input device in accordance with the present invention. For example, the overlapped cell may not be divided, and the clusters may not be joined.

In addition, a sequence of the respective steps may be changed. For example, the clusters may be joined after calculating first the center point coordinates, and the overlapped cells may be divided after joining the clusters. In addition, the overlapped cell dividing step S220 may be performed during the clustering operation (S120) in the clustering step.

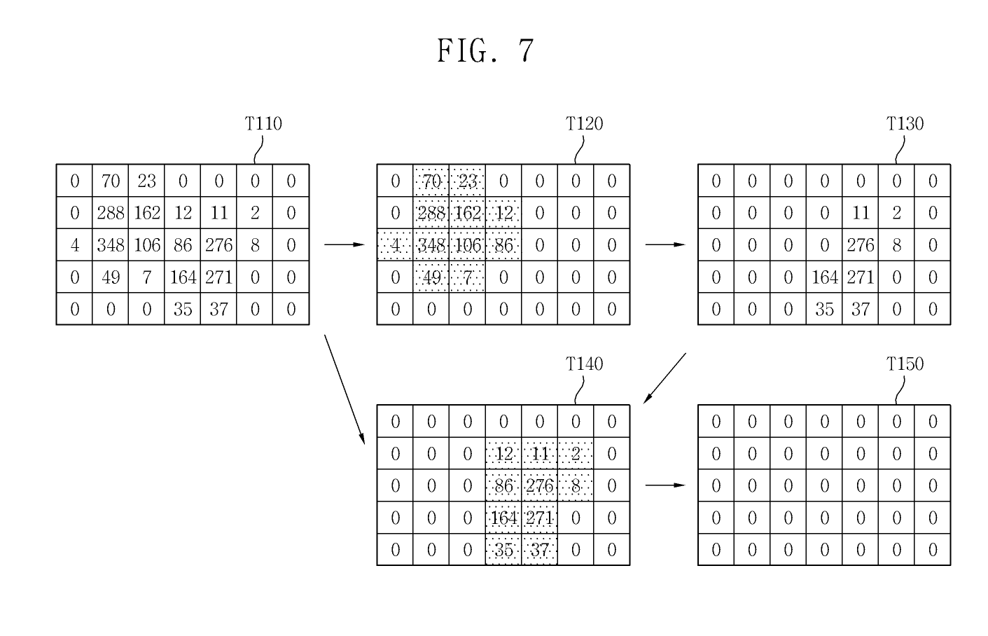

FIG. 7 is a view for explaining the first embodiment of the clustering method of the touch position detecting method of the input device in accordance with the present invention. In FIG. 7, T110 represents a raw frame, T120 and T140 represent clusters, and T130 and T150 represent link frames.

The first embodiment of the clustering method of the touch position detecting method of the input device in accordance with the present invention will be described with reference to FIG. 7.

First, the raw frame T110 has a maximum value. The maximum value is 348 of a third row and a second column.

Next, in the raw frame T110, an increase or decrease in the number of cells in vertical and horizontal directions is detected with reference to the cell (the third row and the second column of the raw frame T110) having the maximum value, and the reduced number of cells are included in the same cluster as the cell having the maximum value. In the case of the vertical direction, the value is continuously decreased to a first row and a second column, and decreased to a fourth row and a second column (the value of the cell of 0 or smaller than the threshold value may be neglected). Accordingly, the cells of the first row and the second column, the second row and the second column, and the fourth row and the second column of the raw frame T110 constitute the same cluster as the cell (the third row and the second column) having the maximum value. In the case of the horizontal direction, the value is decreased to a third row and a first column, and decreased to a third row and a fourth column. Accordingly, the cells of the third row and the first column, the third row and the third column, and the third row and the fourth column constitute the same cluster as the cell (the third row and the second column) having the maximum value.

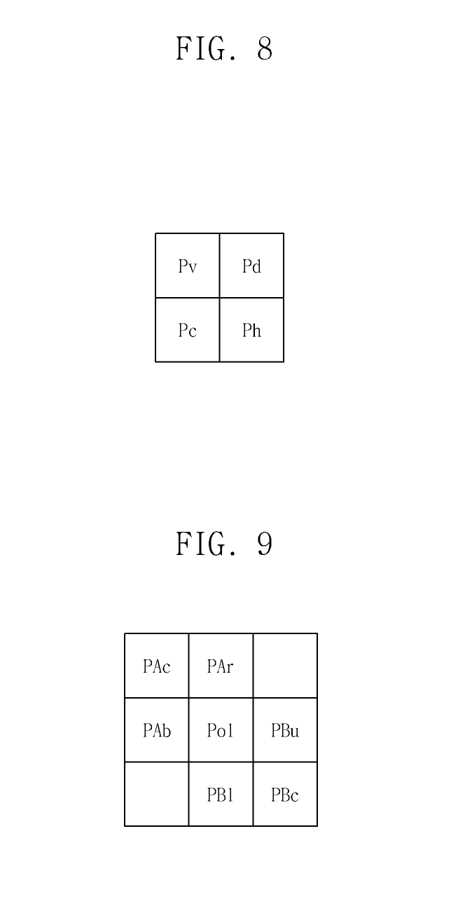

Next, an increase and decrease in the cells in a diagonal direction is detected, and the decreased cells are included in the same cluster as the cell having the maximum value. Referring to the FIG. 8, satisfying all conditions of Ph>0, Pv>0, Pd<Ph+Pv and Pd<Pc, it can be determined that the number of cells in the diagonal direction is decreased. In FIG. 8, Pc represents a reference cell, Pv and Ph represent cells included in the same cluster as the reference cell Pc and adjacent to the reference cell in vertical and horizontal directions, and Pd represents an objective cell adjacent to the reference cell Pc in the diagonal direction and disposed at an intersection point of the Pv and Ph to determine whether it is included in the same cluster as the cell having the maximum value. The reference cell Pc is the cell having the maximum value when the clustering operation of the cells in the diagonal direction is initially performed, and then, determined according to the objective cell Pd included in the same cluster as the cell having the maximum value.

In the raw frame, the cells satisfying the conditions described with reference to the cell (the third row and the second column) having the maximum value become the cell of the first row and the third column, the second row and the third column, the fourth row and the third column, and the second row and the fourth column. Accordingly, the cluster in which the cell (the third row and the second column) having the maximum value is included is provided as T120 of FIG. 7. A region hatched in dots at T120 is the cluster in which the cell (the third row and the second column) having the maximum value is included.

Next, a link frame T130 is calculated by subtracting the first cluster T120 from the raw frame T110.

Next, the maximum value is detected from the link frame T130. The cell having the maximum value in the link frame is at a third row and a fifth column.

Next, when the clustering operation is performed with reference to the cell (the third row and the fifth column) having the maximum value in the raw frame T110 through the same method as the method of obtaining the cluster T120, a second cluster T140 can be obtained. A region hatched in dots at T140 is the cluster in which the cell (the third row and the fifth column) having the maximum value is included.

Next, the second link frame T150 is calculated by subtracting the second cluster T140 from the link frame T130. Since there is no cell larger than the threshold value (here, provided that the threshold value is 0) in the second link frame T150, the clustering operation is stopped.

FIG. 9 is a view for explaining a method of dividing overlapped cells in the touch position detecting method of the input device in accordance with the present invention. In FIG. 9, Pol represents the overlapped cell, and PAc, PAr, PAb, PBu, PBl, and PBc represent cells adjacent to the overlapped cell Pol, respectively. In addition, the adjacent cells PAc, PAr and PAb, and the adjacent cells PBu, PBl and PBc are cells included in another cluster.

When Xa is a value divided into the cluster in which the adjacent cells PAc, PAr and PAb of the overlapped cell Pol are included and Xb is a value divided into the cluster in which the adjacent cells PBu, PBl and PBc of the overlapped cell Pol are included, Xa and Xb can be determined by the following formula 1.

$$Xa = \frac{PAc + PAr + PAb}{PAc + PAr + PAb + PBu + PBl + PBc} \times Pol \\ Xb = \frac{PBu + PBl + PBc}{PAc + PAr + PAb + PBu + PBl + PBc} \times Pol \qquad [ Formula 1 ]$$

In addition, Xa and Xb can be simply determined by the following formula 2.

$$Xa = \frac{PAr + PAb}{PAr + PAb + PBu + PBl} \times Pol \\ Xb = \frac{PBu + PBl}{PAr + PAb + PBu + PBl} \times Pol \qquad [ Formula 2 ]$$

As described above, the overlapped cell dividing operation may be performed during the clustering operation, or may be performed during an operation of determining coordinates of a touch position of each cluster.

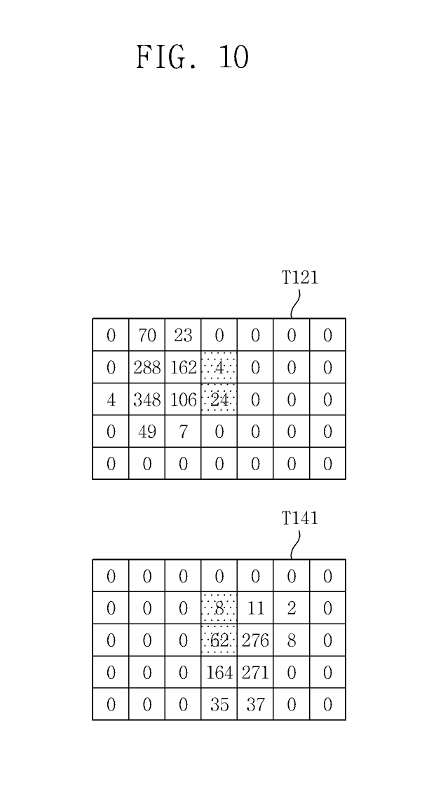

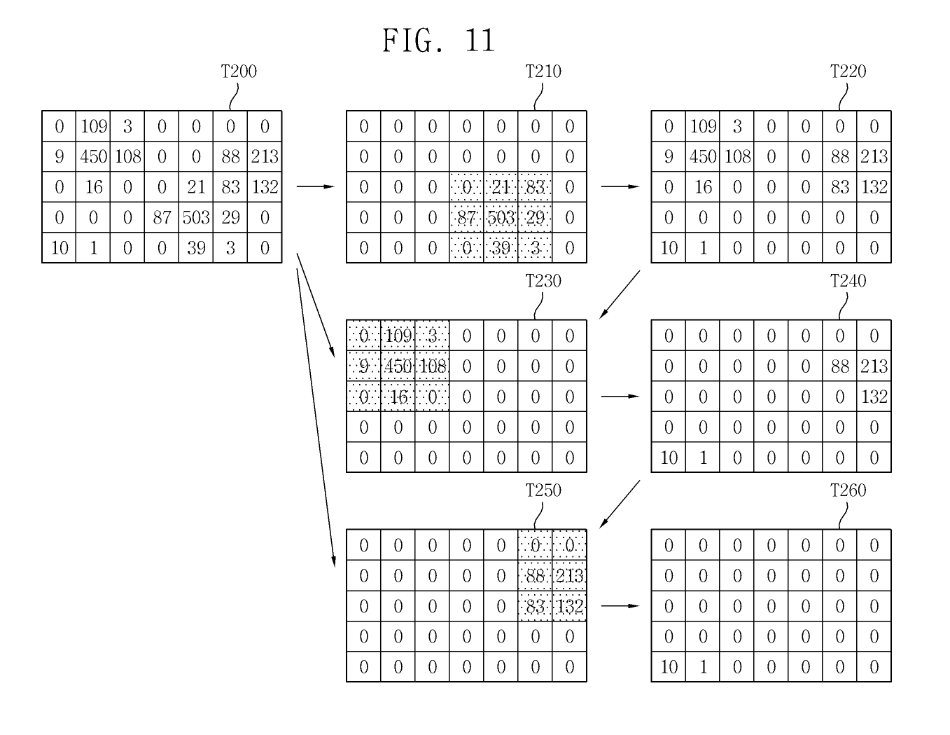

FIG. 10 shows clusters T121 and T141 after performing the overlapped cell dividing operation on the clusters T120 and T140 detected according to the first embodiment of the clustering method of the touch position detecting method of the input device in accordance with the present invention shown in FIG. 7, showing the clusters T121 and T141 in which the overlapped cells (the second row and the fourth column, and the third row and the fourth column) are divided according to formula 1.

First, formula 1 is applied to the cell of the third row and the fourth column as follows.

$$Xa = \frac{162 + 4 + 106}{162 + 4 + 106 + 276 + 164 + 271} \times 86 ≅ \\ Xb = \frac{276 + 164 + 271}{162 + 4 + 106 + 276 + 164 + 271} \times 86 ≅$$

In the above formulae, Xa represents an element of the cluster T121 among values of the cells of the third row and the fourth column, and Xb represents an element of the cluster T141 among values of the cell of the third row and the fourth column.

Similarly, applying formula 1 to the cell of the second row and the fourth column, the element of the cluster T121 becomes about 4, and element of the cluster T141 becomes about 8.

Next, the coordinate determining method of the touch position detecting method of the input device in accordance with the present invention will be described as follows. As described above, coordinates (i.e., center point coordinates) of the touch position of the touch object with each cluster may be calculated using a weighted average. That is, the center point coordinates may be coordinates of a weighted geometrical center of the cluster.

When a value of an ith row and a jth column of the cluster is Vij, an x-axis coordinate value of the touch position of the touch object is T_Cx, and a y-axis coordinate value of the touch position of the touch object is T_Cy, the x-axis coordinate value T_Cx and the y-axis coordinate value T_Cy can be determined by the following formula 3. In formula 3, n represents the number of rows of the cluster, and m represents the number of columns of the cluster.

$$T\_Cx = \frac{{\sum }_{i = 1}^{m} ( ( {\sum }_{i = 1}^{n} Vij ) \times i )}{{\sum }_{i = 1}^{m} ( {\sum }_{i = 1}^{n} Vij )} \\ T\_Cy = \frac{{\sum }_{i = 1}^{n} ( ( {\sum }_{i = 1}^{m} Vij ) \times j )}{{\sum }_{i = 1}^{n} ( {\sum }_{i = 1}^{m} Vij )} \qquad [ Formula 3 ]$$

In the above formula, Vij may be the measurement value P_V or the objective pP_V, and may be a value calculated by subtracting an offset value from the measurement value P_V or the objective pP_V. The offset values may be values for offsetting influence caused by a difference between the touch pads such as a difference in shape or area of the respective touch pads PA11 to PA44 and PB11 to PB44, may be values for offsetting influence caused by a shape of the touch pad part 11 such as a difference in distance between the touch pads PA11 to PA44 and PB11 to PB44 and the channels ch1 to ch(n), or may be values for offsetting influence caused by other peripheral environments. These offset values may be set by a manufacturer or a user.

Coordinates (i.e., center point coordinates) of each touch position of the clusters can be obtained as follows by applying formula 3 to the clusters T121 and T141 shown in FIG. 10.

An x-axis coordinate of the center point coordinates of the cluster T121 is

$$\frac{\begin{matrix}4 \times 1 + ( 70 + 288 + 348 + 49 ) \times 2 + \\ ( 23 + 162 + 106 + 7 ) \times 3 ( 4 + 24 ) \times 4\end{matrix}}{\begin{matrix}4 + ( 70 + 288 + 348 + 49 ) + \\ ( 23 + 162 + 106 + 7 ) + ( 4 + 24 )\end{matrix}} ≅ 2.32 ,$$

and

a y-axis coordinate of the center point coordinates of the cluster T121 is

$$\frac{\begin{matrix}( 70 + 23 ) \times 1 + ( 288 + 162 + 4 ) \times 2 + \\ ( 4 + 348 + 106 + 24 ) \times 3 + ( 49 + 7 ) \times 4\end{matrix}}{\begin{matrix}( 70 + 23 ) + ( 288 + 162 + 4 ) + \\ ( 4 + 348 + 106 + 24 ) + ( 49 + 7 )\end{matrix}} ≅ 2.46 .$$

Calculating it through the same method, the center point coordinates of the cluster T141 become (4.70, 3.64).

FIG. 11 is a view for explaining a second embodiment of the clustering method of the touch position detecting method of the input device in accordance with the present invention.

First, a maximum value is detected from a raw frame T200. A cell having the maximum value is a fourth row and a fifth column.

Next, a clustering operation is performed such that a certain region of cells with reference to the cell (the fourth row and the fifth column) having the maximum value constitute the same cluster (T210). In the embodiment shown in FIG. 11, eight cells adjacent to the cell (the fourth row and the fifth column) having the maximum value constitute one cluster T210 (see a portion hatched in dots at T210).

Next, a first link frame T220 is calculated by subtracting the first cluster T210 from the raw frame T200.

Next, a maximum value is detected from the first link frame T220. A cell having the maximum value is a second row and a second column.

Next, a clustering operation is performed in the raw frame T200 such that a certain region of cells with reference to the cell (the second row and the second column) having the maximum value constitutes the same cluster T230 as the cell (the second row and the second column) having the maximum value.

Next, a second link frame T240 is calculated by subtracting a second cluster T230 from the first link frame T220.

Next, a maximum value is detected from the second link frame T240. A cell having the maximum value is a second row and a seventh column.

Next, a clustering operation is performed in the raw frame T200 such that a certain region of cells with reference to the cell (the second row and the seventh column) having the maximum value constitute the same cluster T250 as the cell (the second row and the seventh column) having the maximum value.

Next, a third link frame T260 is calculated by subtracting the third cluster T250 from the second link frame T240.

Since there is no cell having a value larger than a threshold value (here, the threshold value is assumed as 80. The threshold value may be set by a manufacturer or a user.) in the third link frame T260, the clustering operation is terminated.

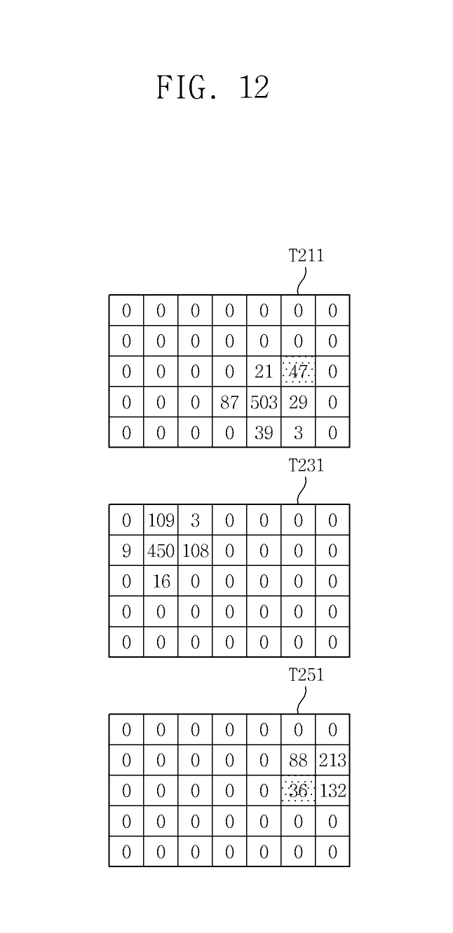

FIG. 12 is a view showing clusters when an overlapped cell dividing operation is performed on the cluster detected according to the second embodiment of the clustering method of the touch position detecting method of the input device shown in FIG. 11 in accordance with the present invention.

The overlapped cell (the third row and the sixth column) of the first cluster T210 and the third cluster T250 may be divided according to FIG. 9 and formula 1 to become the clusters T211 and T251 of FIG. 12.

Next, when coordinates, that is, center point coordinates of the touch position of the touch object with each cluster are calculated, center point coordinates of the cluster T211, the cluster T231 and the cluster T251 become (4.99, 3.96), (2.15, 1.86) and (6.74, 2.36), respectively.

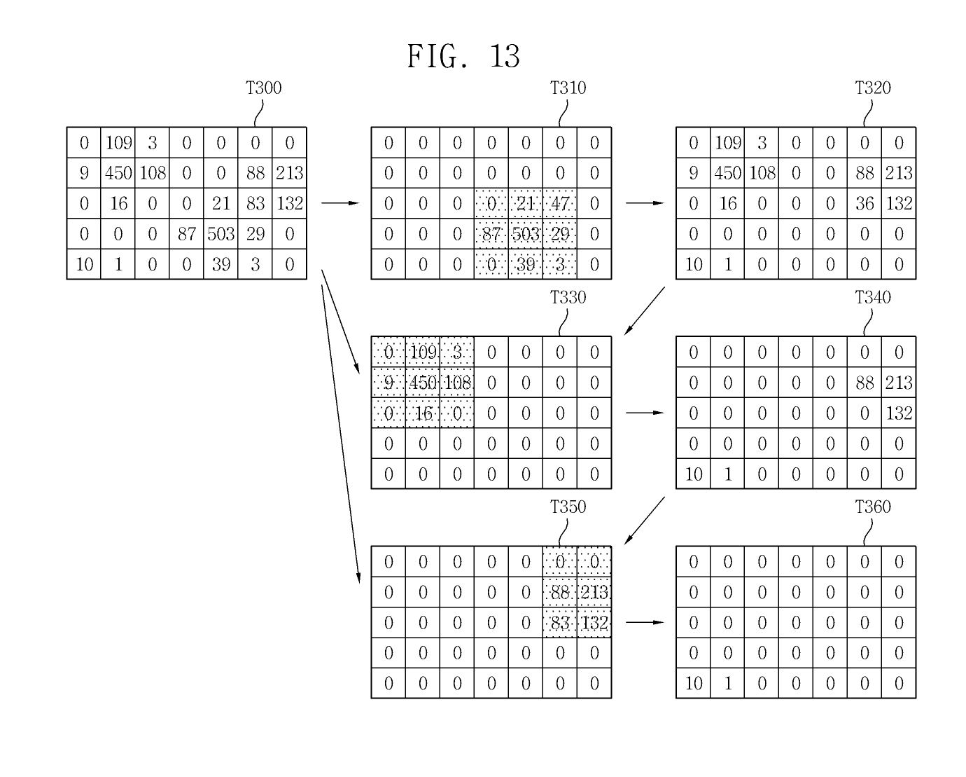

FIG. 13 is a view for explaining a third embodiment of the clustering method of the touch position detecting method of the input device in accordance with the present invention.

First, a maximum value is detected from a raw frame T300. A cell having the maximum value is a fourth row and a fifth column.

Next, a clustering operation is performed in the raw frame T300 such that a certain region of cells with reference to the cell (the fourth row and the fifth column) having the maximum value constitute the same cluster as the cell (the fourth row and the fifth column) having the maximum value. At this time, an overlapped cell (a third row and a sixth column) is detected with reference to values of adjacent cells, and an element of the cluster, in which the cell (the fourth row and the fifth column) having the maximum value is included, among elements of the overlapped cell (the third row and the sixth column) is calculated using formula 1. Accordingly, a value of the overlapped cell (the third row and the sixth column) of the first cluster T310 is 47.

Next, a first link frame T320 is calculated by subtracting the first cluster T310 from the raw frame T300.

Next, a maximum value is detected from the first link frame T320. A cell having the maximum value of the first link frame T320 is a second row and a second column.

Next, a clustering operation is performed in the first link frame T320 such that a certain region of cells with reference to the cell (the second row and the second column) having the maximum value constitute the same cluster T330 as the cell (the second row and the second column) having the maximum value. At this time, since there is no overlapped cell with reference to values of the cells adjacent to the second cluster T330 in the first link frame T320, an overlapped cell dividing operation is not performed.

Next, a second link frame T340 is calculated by subtracting the second cluster T330 from the first link frame T320.

Next, a maximum value is detected from the second link frame T340. A cell having the maximum value in the second link frame T340 is a second row and a seventh column.

Next, a clustering operation is performed in the second link frame T340 such that a certain region of cells with reference to the cell (the second row and the seventh column) having the maximum value constitute the same cluster T350. Since there is no overlapped cell with reference to values of the cells adjacent to the third cluster T350 in the second link frame T340, an overlapped cell dividing operation is not performed.

Next, a third link frame T360 is calculated by subtracting the third cluster T350 from the second link frame T340.

When it is detected that there is no cell having a value larger than the threshold in the third link frame T360, the clustering operation is terminated.

It will be appreciated that the clusters T310, T330 and T350 of FIG. 13 are equivalent to the clusters T211, T231 and T251 of FIG. 12. Accordingly, center point coordinates of the clusters T310, T330 and T350 of FIG. 13 have the same values as described with reference to FIG. 12, respectively.

The foregoing description concerns an exemplary embodiment of the invention, is intended to be illustrative, and should not be construed as limiting the invention. The present teachings can be readily applied to other types of devices and apparatuses. Many alternatives, modifications, and variations within the scope and spirit of the present invention will be apparent to those skilled in the art.

1. An input device comprising:
a touch panel part configured to output a measurement value according to a touch position of a touch object; and
a touch position detecting part configured to generate a raw frame based on the measurement value and generate at least one cluster with reference to a cell having a maximum value in the raw frame, wherein, when there is an overlapped cell simultaneously included in a plurality of clusters, the touch position detecting part performs a clustering operation of dividing a value of the overlapped cell into values of the plurality of clusters according to values of cells adjacent to the overlapped cell and generating the at least one cluster, and calculates coordinates of the touch position with respect to each of the at least one cluster.

2. The input device according to claim 1, wherein, when there is an overlapped cell and the overlapped cell is simultaneously included in a first cluster and a second cluster, the touch position detecting part divides the overlapped cell into the first cluster and the second cluster according to a ratio of a sum of cells included in the first cluster among cells adjacent to the overlapped cell and a sum of cells included in the second cluster among the cells adjacent to the overlapped cell.

3. The input device according to claim 1, wherein, when there is an overlapped cell and the overlapped cell is simultaneously included in a first cluster and a second cluster, the touch position detecting part divides the overlapped cell into the first cluster and the second cluster according to a ratio of a sum of cells included in the first cluster among cells adjacent to upper, lower, left and right sides of the overlapped cell and a sum of cells included in the second cluster among the cells adjacent to the upper, lower, left and right sides of the overlapped cell.

4. The input device according to claim 1, wherein the touch position detecting part calculates the coordinates of the touch position by calculating a weighted geometrical center of each of the at least one cluster.

5. The input device according to claim 1, wherein the touch position detecting part performs the clustering operation to detect an increase or decrease of each cell adjacent to the cell having the maximum value of the raw frame with reference to the cell having the maximum value such that cells reduced with reference to the cell having the maximum value of the adjacent cells constitute the same cluster as the cell having the maximum value.

6. The input device according to claim 5, wherein the touch position detecting part calculates a link frame by subtracting the cluster from the raw frame, detects a cell having a maximum value in the link frame, and detects an increase or decrease with respect to each of the cells adjacent to the cell of the raw frame corresponding to the cell having the maximum value of the link frame with reference to the cell of the corresponding raw frame, thereby performing the clustering operation.

7. The input device according to claim 6, wherein the touch position detecting part performs the clustering operation until all cells of the link frame are equal to or less than a threshold value.

8. The input device according to claim 1, wherein the touch position detecting part performs a clustering operation such that a certain region of cells around the cell having the maximum value constitute one cluster.

9. The input device according to claim 8, wherein the touch position detecting part calculates a link frame by subtracting the cluster from the raw frame, detects a cell having a maximum value in the link frame, and performs the clustering operation such that a certain region of cells in the raw frame constitute one cluster around a cell of the raw frame corresponding to a cell having a maximum value in the link frame.

10. The input device according to claim 9, wherein the touch position detecting part performs the clustering operation until all cells of the link frame are equal to or less than a threshold value.

11. The input device according to claim 8, wherein the touch position detecting part calculates a link frame by subtracting the cluster from the raw frame, detects a cell having a maximum value in the link frame, and performs the clustering operation such that a certain region of cells of the link frame constitutes one cluster around a cell having a maximum value in the link frame.

12. The input device according to claim 11, wherein the touch position detecting part performs the clustering operation until all cells of the link frame are equal to or less than a threshold value.

13. The input device according to claim 1, wherein the touch position detecting part combines clusters having a distance therebetween equal to or less than a reference distance to constitute one cluster.

14. The input device according to claim 1, wherein the touch position detecting part displays that there is a large touch when a size of the cluster is equal to or larger than a reference size.

15. The input device according to claim 1, wherein the touch panel part comprises:
a touch pad part having a plurality of touch pads disposed on one layer and connected to channels corresponding thereto, respectively; and
a delay time measuring part configured to measure capacitances of the plurality of touch pads through the channels to output the measurement value.

16. The input device according to claim 15, wherein the plurality of touch pads are disposed on the one layer in a matrix and spaced apart from each other.

17. The input device according to claim 15, wherein the delay time measuring part comprises:
a pulse generating part configured to generate a pulse signal;
a plurality of detection signal generating parts connected to the channels, respectively, and configured to delay the pulse signal according to the capacitances of the touch pads connected to the channels to output a plurality of detection signals;
a reference signal generating part configured to output a reference signal in response to the pulse signal; and
a delay time calculating part configured to calculate a delay time difference between each of the plurality of detection signals and the reference signal and output the delay time difference as the measurement value.

18. The input device according to claim 15, wherein the plurality of touch pads have different sizes according to positions on the touch pad part, and
connection lines connecting the plurality of touch pads to the channels corresponding thereto, respectively, have different lengths according to positions on the touch pad part.

19. The input device according to claim 18, further comprising a pre-processing part configured to input the measurement value to remove noises, and compensate a difference in size of the touch pads and a difference in length of the connection lines.

20. The input device according to claim 1, further comprising a post-processing part configured to input the coordinates of the touch position to remove noises, and align and output the coordinates.

21. The input device according to claim 1, wherein the touch position detecting part comprises:
a clustering part configured to perform a clustering operation of generating the raw frame based on the measurement value, detecting a maximum value of the measurement value, and generating the at least one cluster with reference to the cell having the maximum value in the raw frame; and
a center point calculating part configured to calculate center point coordinates of each of the clusters using a weighted average of each cluster, and output the center point coordinates as the coordinates of the touch position.

22. The input device according to claim 21, wherein the center point calculating part calculates the center point coordinates after subtracting an offset value from the cells constituting each of the clusters.

23. A touch position detecting method of an input device having a touch panel part of outputting a measurement value according to a touch position of a touch object, which comprises:
generating a raw frame based on the measurement value;
generating a cluster with reference to a cell having a maximum value in the raw frame, wherein, if there is an overlapped cell simultaneously included in a plurality of clusters, a value of the overlapped cell is divided into the plurality of clusters according to a value of cells adjacent to the overlapped cell to generate the at least one cluster; and
calculating coordinates of the touch position with respect to the cluster.

24. The touch position detecting method according to claim 23, wherein, when there is an overlapped cell and the overlapped cell is simultaneously included in a first cluster and a second cluster, generating the cluster divides the overlapped cell into the first cluster and the second cluster according to a ratio of a sum of cells included in the first cluster among cells adjacent to the overlapped cell and a sum of cells included in the second cluster among cells adjacent to the overlapped cell.

25. The touch position detecting method according to claim 23, wherein, when there is an overlapped cell and the overlapped cell is simultaneously included in a first cluster and a second cluster, generating the cluster divides the overlapped cell into the first cluster and the second cluster according to a ratio of a sum of cells included in the first cluster among cells adjacent to upper, lower, left and right sides of the overlapped cell and a sum of cells included in the second cluster among the cells adjacent to the upper, lower, left and right sides of the overlapped cell.

26. The touch position detecting method according to claim 23, wherein calculating the coordinates of the touch position includes calculating the coordinates of the touch position by calculating a weighted geometrical center of each of the at least one cluster.

27. The touch position detecting method according to claim 23, wherein generating the cluster comprises:
detecting an increase or decrease with respect to each of the cells adjacent to the cell having the maximum value of the raw frame with reference to the cell having the maximum value; and
performing a clustering operation such that the cells reduced with reference to the cell having the maximum value among the adjacent cells constitute the same cluster as the cell having the maximum value.

28. The touch position detecting method according to claim 27, further comprising:
calculating a link frame by subtracting the cluster from the raw frame;
detecting a cell having a maximum value in the link frame; and
performing a clustering operation by detecting an increase or decrease with respect to each of the cells adjacent to the cell of the raw frame corresponding to the cell having the maximum value of the link frame with reference to the cell of the corresponding raw frame.

29. The touch position detecting method according to claim 23, wherein generating the cluster includes constituting a certain region of cells around the cell having the maximum value as one cluster.

30. The touch position detecting method according to claim 29, further comprising:
calculating a link frame by subtracting the cluster from the raw frame;
detecting a cell having a maximum value in the link frame; and
performing a clustering operation such that a certain region of cells of the raw frame constitute one cluster around the cell of the raw frame corresponding to the cell having the maximum value in the link frame.

31. The touch position detecting method according to claim 29, further comprising:
calculating a link frame by subtracting the cluster from the raw frame;
detecting a cell having a maximum value in the link frame; and
performing a clustering operation such that a certain region of cells of the link frame constitute one cluster around the cell having the maximum value in the link frame.

32. The touch position detecting method according to claim 23, further comprising combining clusters having a distance therebetween equal to or less than a reference distance into one cluster.

33. The touch position detecting method according to claim 23, further comprising displaying that there is a large touch when a size of the cluster is equal to or larger than a reference size.

34. The touch position detecting method according to claim 23, wherein calculating the coordinates includes calculating center point coordinates of the cluster using a weighted average with respect to the cluster, and outputting the center point coordinates as coordinates of the touch position.

35. The touch position detecting method according to claim 34, wherein calculating the coordinates includes calculating the center point coordinates after subtracting an offset value with respect to each cell constituting the cluster.

36. The touch position detecting method according to claim 23, wherein the touch panel part comprises a plurality of touch pads disposed on one layer to be spaced apart from each other and connected to channels corresponding thereto, respectively,
wherein each of the plurality of touch pads have different sizes according to positions on the touch pad part, and connection lines connecting the plurality of touch pads to the corresponding channels have different lengths according to positions on the touch pad part.

37. The touch position detecting method according to claim 36, further comprising inputting the measurement value to remove noises, and compensating a difference in size of the touch pads and a difference in length of the connection lines connecting the touch pads to the corresponding channels, respectively.

38. The touch position detecting method according to claim 23, further comprising removing noises from the coordinates of the touch position, and aligning and outputting the coordinates of the touch position.
